(19) United States
(12) Patent Application Publication
(10) Pub. No.: US 2018/0356987 A1
(43) Pub. Date: Dec. 13, 2018

(54) INFORMATION PROCESSING SYSTEM, INFORMATION PROCESSING APPARATUS, AND INFORMATION PROCESSING METHOD

(71) Applicant: FUJITSU LIMITED, Kawasaki-shi (JP)

(72) Inventors: Tetsuo Tsujii, Yokohama (JP); Daisuke Butsuda, Yokohama (JP); HIROSHI KATAYAMA, Yokohama (JP); Yutaro Iwakiri, Kawasaki (JP)

(73) Assignee: FUJITSU LIMITED, Kawasaki-shi (JP)

(21) Appl. No.: 15/986,380

(22) Filed: May 22, 2018

(30) Foreign Application Priority Data
Jun. 8, 2017 (JP) 2017-113205

(51) Int. Cl. G06F 3/06; G06F 11/14

(52) U.S. Cl. CPC G06F 3/065; G06F 3/0619; G06F 2201/82; G06F 11/1464; G06F 3/067

(57) ABSTRACT

An information processing system includes a first apparatus including a first memory and a primary processor, and a second apparatus including a second memory, a third memory, and a secondary processor. Upon receiving each of plural data, the primary processor writes the received data in the first memory and transmits the received data to the second apparatus together with first identification information. The secondary processor writes the data in the third memory in association with the first identification information and transmits a completion notification to the first apparatus. The primary processor transmits a plurality of first identification information to the second apparatus upon determining that all of the plural data are written in the third memory. The secondary processor writes, in the second memory, plural data held in the third memory that respectively correspond to the plurality of first identification information.

### CROSS-REFERENCE TO RELATED APPLICATION

This application is based upon and claims the benefit of priority of the prior Japanese Patent Application No. 2017-113205, filed on Jun. 8, 2017, the entire contents of which are incorporated herein by reference.

### FIELD

The embodiments discussed herein are related to an information processing system, an information processing apparatus, and an information processing method.

### BACKGROUND

It is desirable to restore a system as quickly as possible when the system operated by, for example, a company goes down due to an occurrence of a large-scale disaster such as fire, earthquake or tsunami. For example, a first system used in ordinary work is installed along with a second system used when the first system goes down at places separated from each other, and even when the first system goes down, it becomes possible to restore the system using the second system.

For example, the first system has a first memory device and a first cache memory that temporarily stores data before being stored in the first memory device. The second system has a second memory device and a second cache memory that temporarily stores data before being stored in the second memory device. In a normal operation before the disaster occurs, the first system that receives data from, for example, a data processing apparatus that executes data processing, stores the received data in the first memory device via the first cache memory.

The first system copies the data stored in the first memory device to the second cache memory included in the second system at a predetermined frequency. The second system stores the data copied to the second cache memory in the second memory device. In addition, when the first system goes down due to, for example, an occurrence of the disaster, the operation of the system is switched from the first system to the second system and the operation by the second system starts by using the data held by the second memory device.

For example, the first system stores data included in a write request from the data processing apparatus in the first cache memory and transmits the data included in the write request and time information indicating a write time included in the write request to the second system. The second system stores the received data in the second cache memory. The second system extracts a predetermined number of data among the data stored in the second cache memory in an order of an older write time based on the time information and writes the extracted data in the second memory device. When a failure occurs in transmitting data from the first system to the second system, the second system selects data to be discarded among the data stored in the second cache memory based on the time information.

In a database management system, the data and a log indicating update contents of the data are stored in the first memory device, and the data and the log stored in the first memory device are copied to the second memory device. In this case, copying the data to the second memory device is performed by an asynchronous remote copying in which a completion for the write request is notified before transmitting the data to a recovery site while guaranteeing the sequence of writing the data. Copying the log to the second memory device is performed by a synchronous remote copying in which the completion for the write request is notified after transmitting the data to the recovery site.

Related technologies are disclosed in, for example, Japanese Laid-Open Patent Publication Nos. 2006-004147, 2006-024229, and 2005-267301.

### SUMMARY

According to an aspect of the present invention, provided is an information processing system including a first information processing apparatus and a second information processing apparatus. The first information processing apparatus includes a first memory and at least one primary processor coupled to the first memory. The second information processing apparatus includes a second memory, a third memory, and at least one secondary processor coupled to the second memory and the third memory. The at least one primary processor is configured to write, upon receiving each of plural pieces of data, the received piece of data in the first memory. The plural pieces of data are included in a data group. The at least one primary processor is configured to transmit the received piece of data to the second information processing apparatus together with first identification information for identifying the received piece of data. The at least one secondary processor is configured to write the piece of data in the third memory in association with the first identification information upon receiving the piece of data together with the first identification information. The at least one secondary processor is configured to transmit a completion notification to the first information processing apparatus. The completion notification indicates completion of writing. The at least one primary processor is configured to receive the completion notification. The at least one primary processor is configured to determine whether all of the plural pieces of data are written in the third memory based on the received completion notification. The at least one primary processor is configured to transmit a plurality of first identification information to the second information processing apparatus upon determining that all of the plural pieces of data are written in the third memory. The plurality of first identification information respectively correspond to the plural pieces of data. The at least one secondary processor is configured to write, in the second memory, plural pieces of data held in the third memory that respectively correspond to the plurality of first identification information received from the first information processing apparatus.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an embodiment of an information processing system, an information processing apparatus and an information processing method;

FIG. 2 is a diagram illustrating an example of an operation of the information processing system illustrated in FIG. 1;

FIG. 3 is a diagram illustrating a separate embodiment of the information processing system, the information processing apparatus and the information processing method;

FIG. 4 is a diagram illustrating an example of a request management table and a data management table of an operation site illustrated in FIG. 3;

FIG. 5 is a diagram illustrating an example of the request management table and the data management table of a stand-by site illustrated in FIG. 3;

FIG. 6 is a diagram illustrating an example of information held in a memory of the stand-by site illustrated in FIG. 3;

FIG. 7 is a diagram illustrating an example of an overview of the operation of the information processing system illustrated in FIG. 3;

FIG. 8 is a diagram illustrating an example of the operation of the information processing system illustrated in FIG. 3;

FIG. 9 is a diagram illustrating continuation of the operation of FIG. 8;

FIG. 10 is a diagram illustrating the continuation of the operation of FIG. 9;

FIG. 11 is a diagram illustrating the continuation of the operation of FIG. 10;

FIG. 12 is a diagram illustrating an example of an operational flow of a request management unit of the operation site illustrated in FIG. 3;

FIG. 13 is a diagram illustrating an example of the operational flow of a data management unit of the operation site illustrated in FIG. 3;

FIG. 14 is a diagram illustrating an example of the operational flow of a communication management unit of the operation site illustrated in FIG. 3;

FIG. 15 is a diagram illustrating an example of the operational flow of the request management unit of the stand-by site illustrated in FIG. 3; and

FIG. 16 is a diagram illustrating an example of the operational flow of the data management unit of the stand-by site illustrated in FIG. 3.

### DESCRIPTION OF EMBODIMENTS

For example, when the size of data is larger than the size that may be transmitted by one transmission, a data processing apparatus handling data to be stored in the first memory device divides the data into sizes that may be transmitted and sequentially transmits each of the plurality of divided data to a first system. Each time the first system receives each of the plurality of divided data from the data processing apparatus, the first system stores the received data in the first memory device and then transmits the stored data to a second system.

The second system stores the received data in a second memory device each time receiving each of the divided plurality of data. For example, when a disaster occurs after all of the plurality of divided data are stored in the first memory device and the first system goes down, the second memory device may not hold some of the data before being divided by the data processing apparatus. When the operation of the system is switched from the first system to the second system in a state where the second memory device does not hold some of the data and the operation by the second system starts, the data processing apparatus restarts data processing by using the data held by the second memory device. However, when the second storage device does not hold some of the data before being divided, the data processing is not executed correctly, and as a result, it is difficult to continue the system operation by the second system.

Hereinafter, embodiments will be described by using drawings.

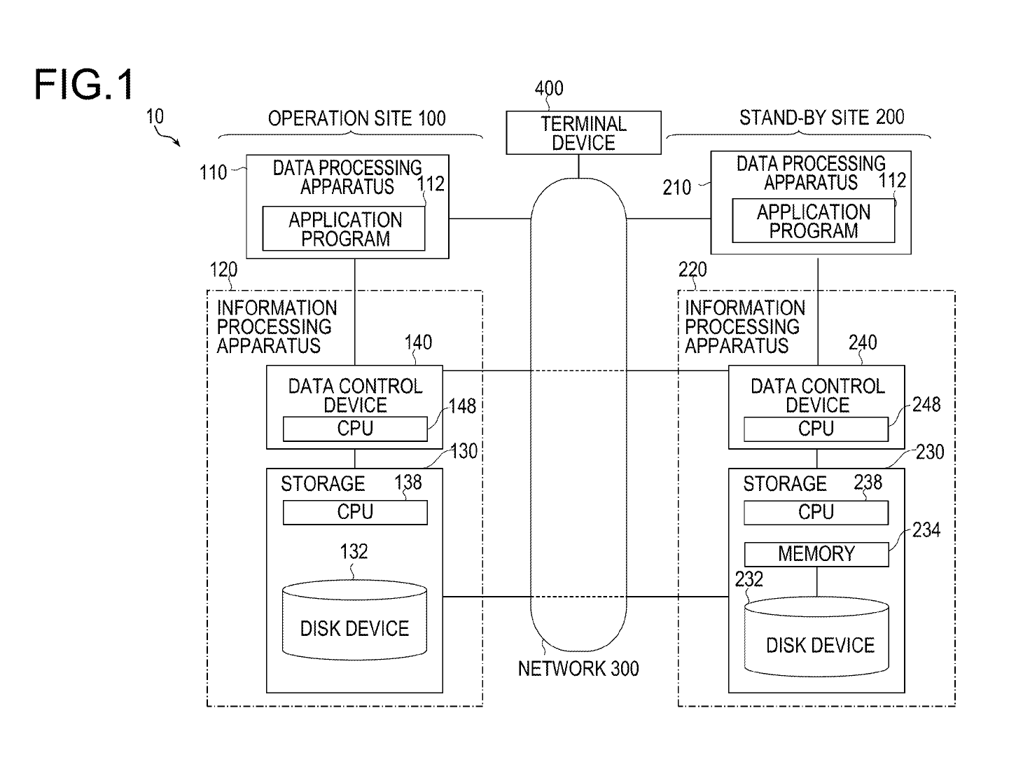

FIG. 1 is a diagram illustrating an embodiment of an information processing system, an information processing apparatus and an information processing method. The information processing system 10 illustrated in FIG. 1 has an operation site 100 and a stand-by site 200 coupled to each other via a network 300 such as, for example, the Internet.

The operation site 100 includes a data processing apparatus 110 and an information processing apparatus 120. The data processing apparatus 110 is, for example, a server, for example, a central processing unit (CPU) included in the server executes an application program 112 to perform, for example, attendance management or performance management of students in a school. The information processing apparatus 120 includes a storage 130 including a disk device 132 that stores data managed by the application program 112, and a data control device 140 that controls the storage 130. The information processing apparatus 120 is an example of a first information processing apparatus, the data control device 140 is an example of a first control device, the storage 130 is an example of a first storage, and the disk device 132 is an example of a first memory. The data control device 140 is a server such as, for example, a CPU 148 included in the server executes an application program to implement various processing performed by the data control device 140. The storage 130 is, for example, a server such as, for example, a CPU 138 included in the server executes an application program to implement various processing performed by the storage 130.

The stand-by site 200 operates on behalf of the operation site 100 when it becomes difficult to continue the operation of the system at the operation site 100 due to a disaster such as fire, earthquake, or tsunami. The stand-by site 200 includes a data processing apparatus 210 and an information processing apparatus 220. For example, the data processing apparatus 210 is a server having the same configuration as the data processing apparatus 110, and for example, a CPU included in the server executes the application program 112 to perform the same data management as the data processing apparatus 110. Further, the data processing apparatus 210 may be configured in a stand-by state or a state in which power is cut off when the operation site 100 is normally operated.

For example, the data processing apparatuses 110 and 210 are coupled to the terminal device 400 via the network 300. The terminal device 400 transmits data to be managed by the information processing system 10 to the data processing apparatus 110 when the operation site 100 is normally operated. Further, the terminal device 400 transmits the data to be managed by the information processing system 10 to the data processing apparatus 210 when the operation site 100 goes down due to, for example, an occurrence of the disaster. That is, the information processing system 10 illustrated in FIG. 1 establishes a disaster recovery system.

The information processing apparatus 220 has a storage 230 and a data control device 240 that controls the storage 230. The storage 230 has a disk device 232 for storing the data transmitted from the storage 130 of the operation site 100 and a memory 234 for temporarily storing data before storing the data in the disk device 232. For example, the disk devices 132 and 232 are the same kind of memory devices having the same memory capacity and each of the disk devices 132 and 232 includes a hard disk drive (HDD) or a solid state drive (SSD). The memory 234 includes, for example, a flash memory, or a static random access memory (SRAM). The information processing apparatus 220 is an example of a second information processing apparatus, the data control device 240 is an example of a second control device, and the storage 230 is an example of a second storage. The disk device 232 is an example of a second memory, and the memory 234 is an example of a third memory. The data control device 240 is, for example, a server such as, for example, a CPU 248 included in the server executes an application program to implement various processing performed by the data control device 240. The storage 230 is, for example, a server such as, for example, a CPU 238 included in the server executes an application program to implement various processing performed by the storage 230.

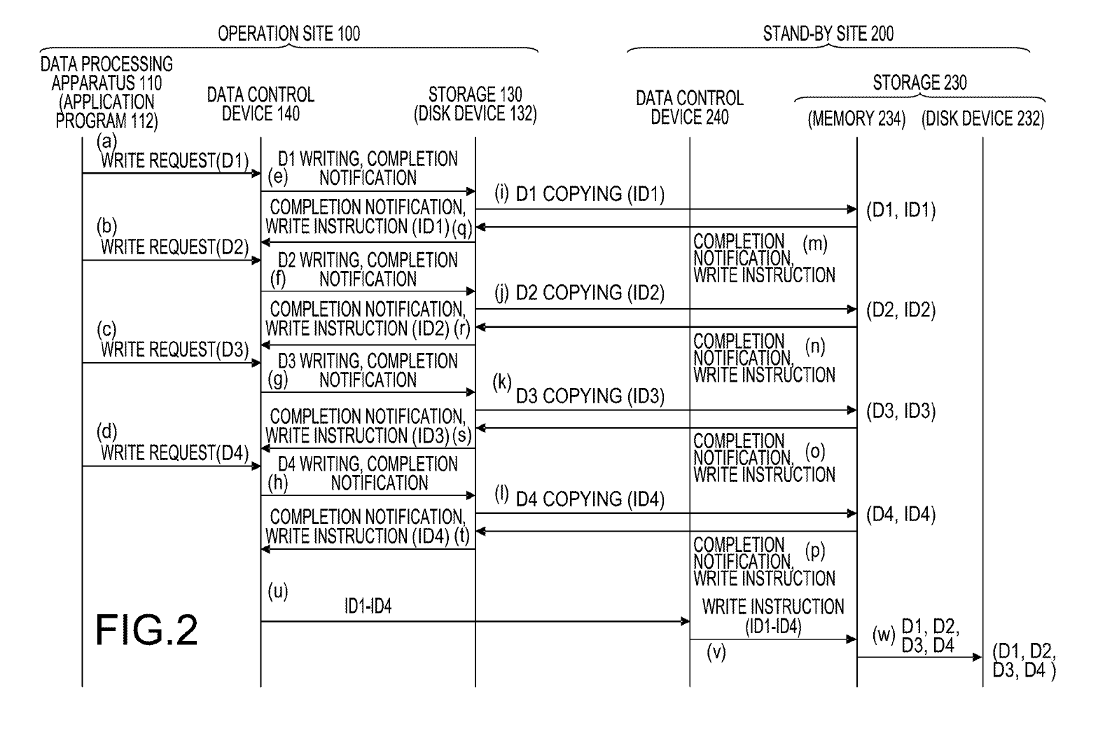

FIG. 2 is a diagram illustrating an example of an operation of the information processing system 10 illustrated in FIG. 1. That is, FIG. 2 illustrates an example of an information processing method by the information processing system 10. In FIG. 2, the data processing apparatus 110 issues four write requests including any one of respective data D to the data control device 140 in order to store four data D (D1 to D4) included in a data group in the storage 130 ((a), (b), (c), and (d) in FIG. 2).

For example, when the size of the data is larger than the size that may be transmitted by one transmission, the data is divided into data D1, D2, D3, and D4 of a transmittable size and transmitted to the data control device 140. Alternatively, when the application program 112 of the data processing apparatus 110 generates the data D1, D2, D3, and D4 to be integrally managed at different timings, the data D1, D2, D3, and D4 are transmitted to the data control device 140 whenever being generated. In such a manner, the data D1, D2, D3, and D4 included in the data group are, for example, a unit of processing by the application program 112 and have mutual relevance and are integrally managed. That is, the data group including the data D1, D2, D3, and D4 is a unit of data managed by the data processing apparatuses 110 and 210.

When any one of the data D1, D2, D3, and D4 is missing, the data D1, D2, D3, and D4 are integrated as the data group and stored in the disk device 132 or 232 in order to prevent subsequent processing from being normally executed. By storing the data in the disk device 232 by unit of the data group, the processing may be normally executed even when the operation site 100 goes down and the application program 112 is executed on the stand-by site 200. That is, by storing the data in the disk device 232 by unit of the data group, consistency of the data at an execution level of the application program 112 may be guaranteed.

Each time the data control device 140 receives the write request, the data control device 140 writes the data D included in the write request to the disk device 132 of the storage 130 ((e), (f), (g), and (h) in FIG. 2). The storage 130 copies the data D written in the disk device 132 to the storage 230 without using the data control devices 140 and 240 by using a method such, for example, as remote copy. In this case, the storage 130 transfers an identification information ID (ID1, ID2, ID3, and ID4) for identifying each data D to the storage 230 together with the data D ((i), (j), (k), and (l) in FIG. 2). For example, the identification information ID is address information indicating a memory area where each data D is written, out of a plurality of memory areas included in the disk device 132. Further, the identification information ID may be a numerical value or character information uniquely allocated to each data D. The identification information ID is an example of first identification information.

Each time the storage 230 receives the data D, the storage 230 writes the received data D in the memory 234 in association with the identification information ID and then issues a completion notification indicating the completion of the writing to the storage 130 ((m), (n), (o), and (p) in FIG. 2). Each time the storage 130 receives the completion notification from the storage 230, the storage 130 issues the completion notification including the identification information ID corresponding to the data D of which writing in the memory 234 is completed to the data control device 140 ((q), (r), (s), and (t) in FIG. 2).

The data control device 140 determines that all of the data D1 to D4 included in the data group are written in the memory 234 of the stand-by site 200, based on reception of all the completion notifications corresponding to the data D1 to D4, respectively. In addition, the data control device 140 transmits the identification information ID1 to ID4 corresponding to the data D1 to D4 included in the data group of which writing is completed, respectively to the data control device 240 ((u) in FIG. 2).

The data control device 240 issues to the storage 230 a write instruction to write the data D1 to D4 (that is, data group) held in the memory 234 in association with the received identification information ID1 to ID4 in the disk device 232 ((v) in FIG. 2). The storage 230 that receives the write instruction selects the data D1 to D4 corresponding to the identification information ID1 to ID4, respectively among the plurality of data held in the memory 234 and writes the selected data D1 to D4 in the disk device 232 ((w) in FIG. 2).

As a result, it is possible to write the data D1 to D4 written in the disk device 132 of the operation site 100 in the disk device 232 of the stand-by site 200 by unit of the data group. Further, when the identification information ID is, for example, address information indicating the memory area of the disk device 132 in which the data is written, the storage 230 writes the data in the memory area indicated by the identification information ID in the disk device 232.

As described with reference to FIG. 2, when the storage 130 writes the data D in the memory 234 of the storage 230 without going through the data control device 140, the data control device 140 determines the completion of the writing, based on the identification information ID (address information). Therefore, without newly generating information for determining the completion of the writing by the information processing apparatus 120, the data control device 140 may determine that the data D1 to D4 included in the data group are written in the memory 234. As a result, in the information processing apparatus 120, control of transmission of the plurality of identification information ID1 to ID4 to the data control device 240 may be made easier as compared with a case where information other than the address information is used.

For example, when the operation site 100 goes down due to the occurrence of the disaster before the completion of the writing of the data D3 in the memory 234 among the data D1 to D4 included in the data group, all of the data D1 to D4 are not written in the disk device 232. Therefore, when the operation of the system is switched from the operation site 100 to the stand-by site 200, the data processing apparatus 210 (FIG. 1) which takes over the management of the data continues to perform management without using the data group including the data D1 to D4. Meanwhile, for example, when the operation site 100 goes down due to the occurrence of the disaster after the data D1 to D4 are written in the disk device 232, the data processing apparatus 210 continues to perform management by using the data group including the data D1 to D4 stored in the storage 230.

Contrary to this, each time the storage 230 of the stand-by site 200 receives the data D, the storage 230 is assumed to write the received data D in the disk device 232. When, for example, the operation site 100 goes down due to the occurrence of the disaster before the data D3 is written in the disk device 232, the disk device 232 holds the data D1 and D2 in the data group, but does not hold the data D3 and D4. The data processing apparatus 210 that takes over the management of the data intends to continue managing the data by using correct data D1 and D2 in the data group and incorrect data D3 and D4 which do not actually exist. However, since the data group is incorrect, it becomes difficult to normally take over the management, and as a result, it becomes difficult to continue the system operation.

As described above, in the embodiment illustrated in FIGS. 1 and 2, the data control device 240 writes the data group selected by using the identification information ID among the plurality of data held in the memory 234 in the disk device 232. As a result, it is possible to write the data D1 to D4 written in the disk device 132 of the operation site 100 in the disk device 232 of the stand-by site 200 by unit of the data group which is the unit of the processing by the application program 112, for example.

Therefore, even when the operation site 100 goes down and the application program 112 is executed on the stand-by site 200, the consistency of the data at the execution level of the application program 112 may be guaranteed. In other words, in a state in which a part of the data group is written in the disk device 232, the operation of the system is switched from the information processing apparatus 120 to the information processing apparatus 220 and it is thus possible to prevent the processing from being normally executed. As a result, even when the operation site 100 goes down, the operation of the system may be continued based on the data held in the disk device 232.

Without newly generating information for determining the completion of the writing of the data group in the memory 234 by using the identification information ID, the data control device 140 may determine that the data D1 to D4 included in the data group are written in the memory 234. As a result, in the information processing apparatus 120, the control of transmission of the plurality of identification information ID1 to ID4 to the data control device 240 may be made easier as compared with the case where the information other than the address information is used.

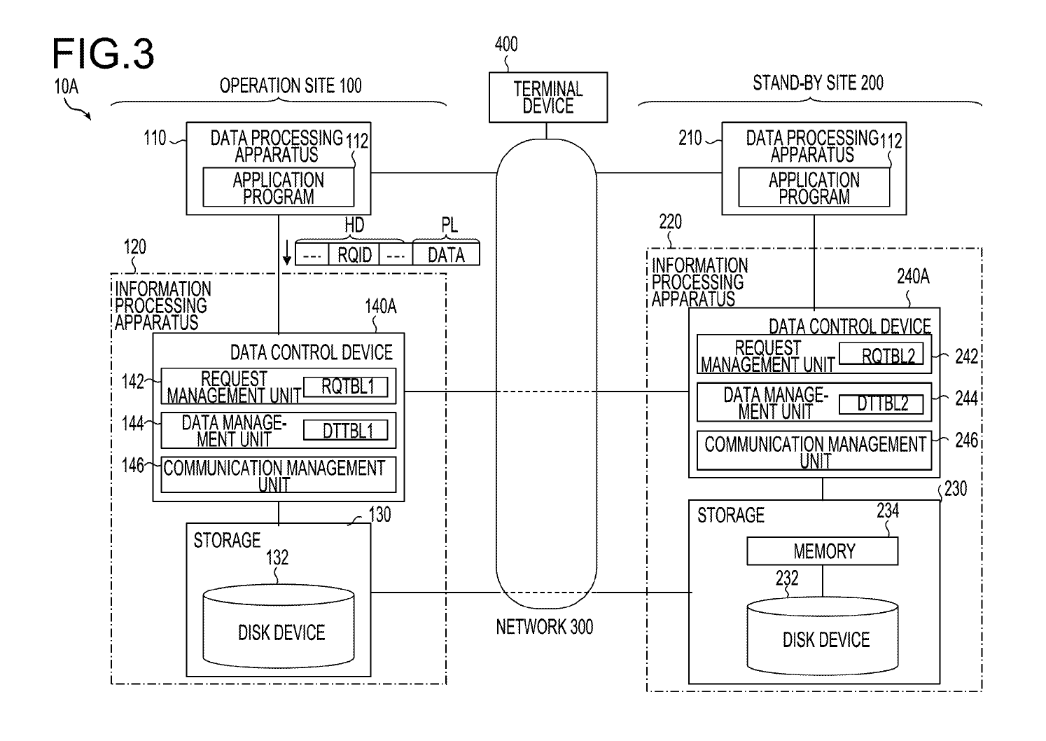

FIG. 3 is a diagram illustrating a separate embodiment of an information processing system, an information processing apparatus and an information processing method. The same or similar elements as those described in the embodiment illustrated in FIG. 1 are denoted by the same reference numerals and a detailed description thereof will be omitted.

In an information processing system 10A illustrated in FIG. 3, the information processing apparatus 120 of the operation site 100 includes a data control device 140A instead of the data control device 140 illustrated in FIG. 1. Further, the information processing apparatus 220 of the stand-by site 200 has a data control device 240A instead of the data control device 240 illustrated in FIG. 1. The other configuration of the information processing system 10A is the same as that of the information processing system 10 illustrated in FIG. 1.

That is, the operation site 100 includes the data processing apparatus 110 and the information processing apparatus 120 that perform the attendance management or the management of the performance of the student in the school. The information processing apparatus 120 includes the storage 130 including the disk device 132 and a data control device 140A that controls the storage 130. The stand-by site 200 has the data processing apparatus 210 and the information processing apparatus 220 having the same configuration as the data processing apparatus 110. The information processing apparatus 220 includes the storage 230 including the memory 234 and the disk device 232 and a data control device 240A that controls the storage 230. The data processing apparatuses 110 and 210, the data control devices 140A and 240A, the storages 130 and 230, and the terminal device 400 are coupled to the network 300. In addition, similarly to FIG. 1, a disaster recovery system is constructed by the information processing system 10A.

The data processing apparatus 110 transmits a write request packet including a header HD and a payload PL including data DATA written in the storage 130 to the data control device 140A. For example, the data processing apparatus 110 sequentially transmits a plurality of packets including each of a plurality of data having mutual relevance to the data control device 140A. The plurality of data having the mutual relevance is also called the data group. The header HD of the packet includes a request number RQID for identifying the data group. The request number RQID is an example of second identification information for identifying the data group.

Before transmitting any one of the data included in the data group as the write request packet to the data control device 140A, the data processing apparatus 110 transmits a transmission start packet indicating a start of transmission of the data group to the data control device 140A. Further, after transmitting all data included in the data group as the write request packet to the data control device 140A, the data processing apparatus 110 transmits the transmission completion packet indicating the completion of the transmission of the data group to the data control device 140A. The transmission start packet and the transmission completion packet do not include the payload PL.

The data control device 140A is the server and has, for example, a request management unit 142, a data management unit 144, and a communication management unit 146 which are implemented by executing a control program by the CPU 148 included in the server. The data control device 140A processes the packet received from the data processing apparatus 110 and when the data is included in the packet, the data control device 140A executes processing of writing the data in the storage 130. Further, the data control device 140A executes processing of transmitting identification information for identifying each of a plurality of data transmitted from the storage 130 to the storage 230 to the data control device 240A for each data group.

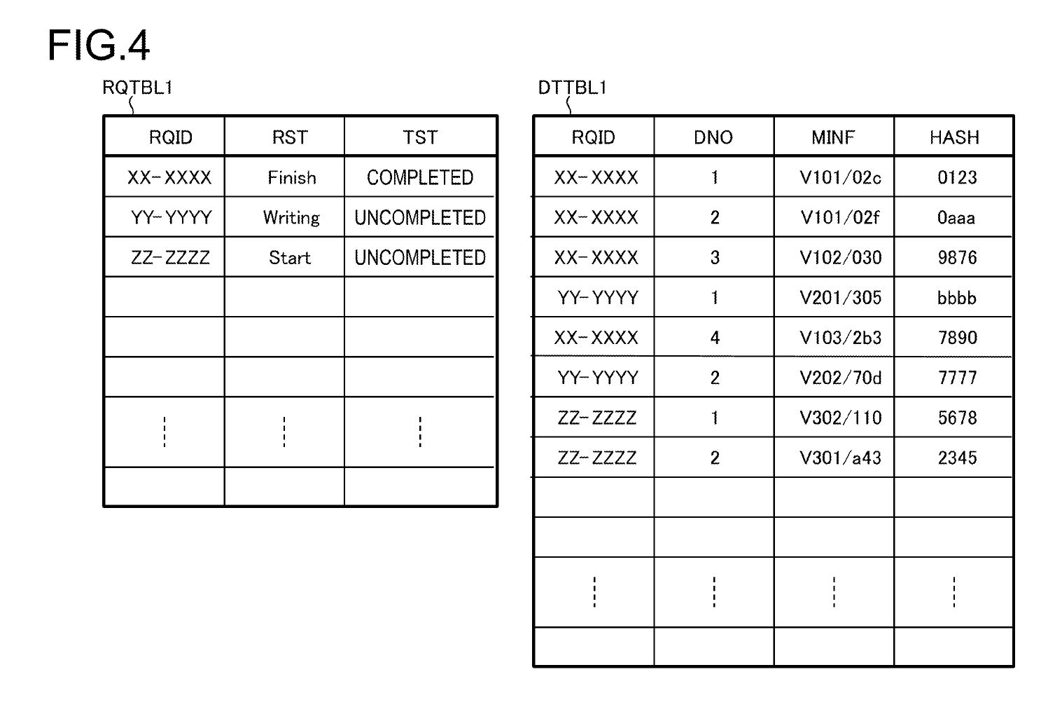

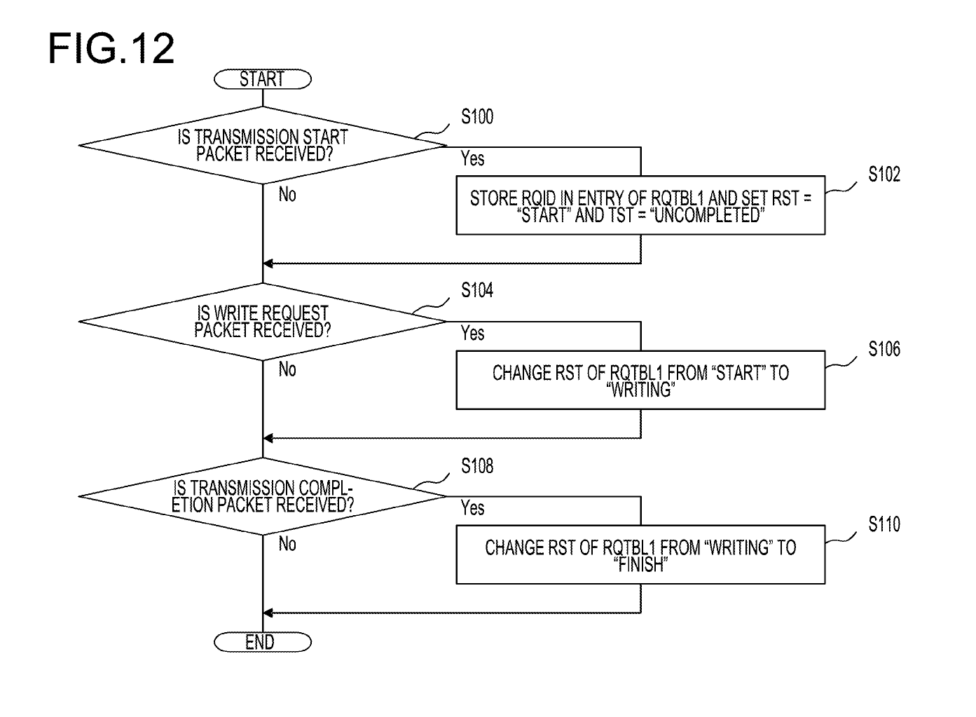

The request management unit 142 manages a data reception status for each data group based on the transmission start packet, the write request packet and the transmission completion packet received from the data processing apparatus 110. Further, the request management unit 142 manages a transmission status of the data group to the data control device 240A. The request management unit 142 manages the reception status and the transmission status of the data group by using a request management table RQTBL1. The example of the request management table RQTBL1 is illustrated in FIG. 4 and the example of the operation of the request management unit 142 is illustrated in FIG. 12.

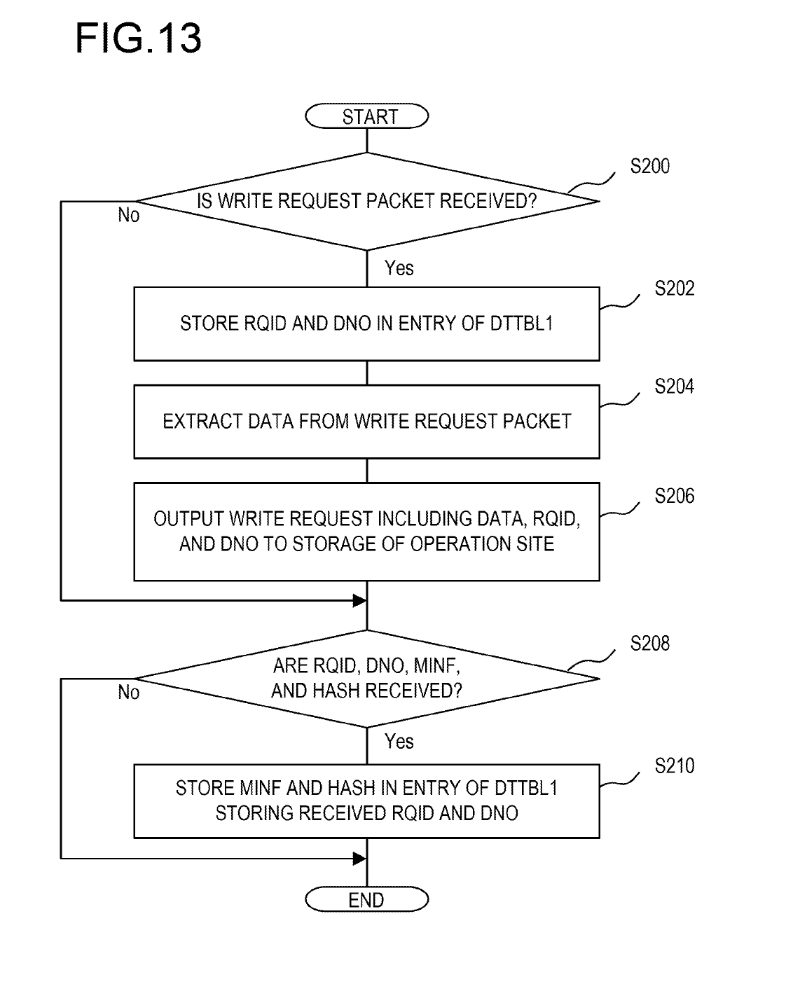

For each data included in the write request, the data management unit 144 manages, for example, identification information for identifying the data written in the disk device 132 by using the data management table DTTBL1. The example of the data management table DTTBL1 is illustrated in FIG. 4 and the example of the operation of the data management unit 144 is illustrated in FIG. 13.

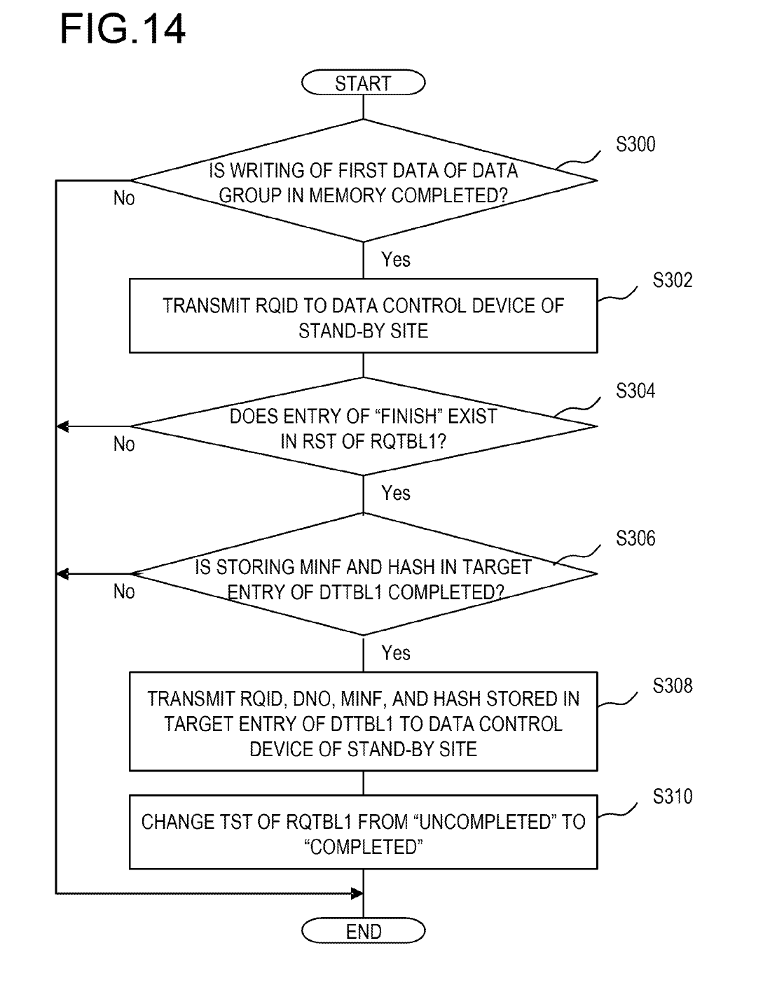

The communication management unit 146 manages communication with the data control device 240A of the stand-by site 200. For example, after the data group written in the disk device 132 is written from the storage 130 in the memory 234 of the storage 230, the communication management unit 146 controls information related to the data group held in the data management table DTTBL1 to the data control device 240A. The example of the operation of the communication management unit 146 is illustrated in FIG. 14.

The data control device 240A is, for example, the server and has, for example, a request management unit 242, a data management unit 244, and a communication management unit 246 which are implemented by executing the control program by the CPU 248 included in the server. Based on the information received from the data control device 140A, the data control device 240A executes processing of writing the data written from the storage 130 into the memory 234 in the disk device 232 for each data group. Further, when the operation site 100 goes down due to the occurrence of the disaster and the operation of the system is switched from the operation site 100 to the stand-by site 200, the data control device 240A processes the packet received from the data processing apparatus 210. In addition, the data control device 240A executes processing of writing the data included in the packet in the storage 230.

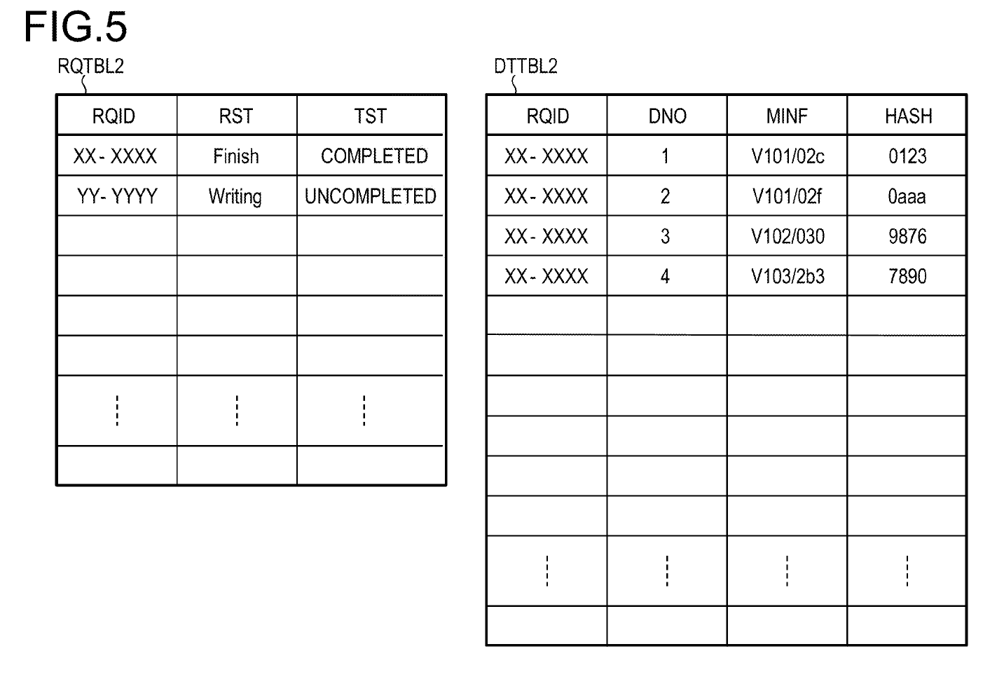

The request management unit 242 manages the reception status and the transmission status of the data group by the data control unit 140A using a request management table RQTBL2 based on the information received via the communication management unit 146 of the operation site 100. The example of the request management table RQTBL2 is illustrated in FIG. 5.

The data management unit 244 manages information related to the data group held in the data management table DTTBL1 received from the communication management unit 146 of the operation site 100 by using a data management table DTTBL2. The example of the data management table DTTBL2 is illustrated in FIG. 5. The communication management unit 246 manages communication with the data control device 140A.

FIG. 4 is a diagram illustrating an example of a request management table RQTBL1 and a data management table DTTBL1 of an operation site 100 illustrated in FIG. 3. The request management table RQTBL1 has a plurality of entries including areas RQID, RST, and TST, respectively. In the area RQID, request numbers RQID (XX-XXXX, YY-YYYY, ZZ-ZZZZ, etc.) allocated for each data group are stored.

In the area RST, the reception status of the plurality of data included in the data group from the data processing apparatus 110 is stored. The reception status is indicated by any one of “Start,” “Writing,” or “Finish.” “Start” indicates that the data processing apparatus 110 starts transmitting the plurality of data included in the data group. “Writing” indicates that the data processing apparatus 110 transmits any one of the plurality of data included in the data group. “Finish” indicates that transmission from the plurality of data included in the data group from the data processing apparatus 110 is completed.

In the area TST, the transmission status of the information related to the data group to the data control device 240A is stored. The transmission status is indicated by any one of “uncompleted” or “completed.” “Uncompleted” indicates that the information related to the data group is not transmitted to the data control device 240A. “Completed” indicates that transmission of the information related to the data group to the data control device 240A is completed.

The data management table DTTBL1 has a plurality of entries including areas RQID, DNO, MINF, and HASH, respectively. Similarly to the request management table RQTBL1, the request number RQID allocated for each data group is stored in the area RQID. In the area DNO, numbers for identifying the plurality of data included in the data group are stored. For example, the numbers are assigned by the data management unit 144 in the order of receiving the data for each data group. Hereinafter, the number stored in the area DNO is also referred to as a data number DNO.

In the area MINF, information indicating the memory area of the disk device 132 in which the data is written is stored as the information for identifying the data. In the example illustrated in FIG. 4, the information indicating the memory area includes a logical unit number (LUN) for identifying the memory area logically divided in the disk device 132 and a number of a memory block such as, for example, a sector included in the memory area indicated by the LUN. Hereinafter, it is assumed and described that the memory block included in the LUN is the sector. In FIG. 4, the LUN is indicated, for example, by “V101,” “V102,” and the sector numbers are indicated by, for example, “02c,” “030” (hexadecimal). Hereinafter, the information stored in the area MINF is also referred to as memory area information MINF. The memory area information MINF is notified to the data management unit 144 from the storage 130 that writes the data in the disk device 132.

A hash value of information (bit string) held by the sector in which the data is written is stored in the area HASH. The information held by the sector in which the data is written is an example of area data and is hereinafter also referred to as area data. The hash value is calculated by the storage 130 and notified from the storage 130 to the data management unit 144. In FIG. 4, the hash value is indicated by a 4-digit hexadecimal number, but is not limited to 4 digits. Hereinafter, the hash value stored in the area HASH is also referred to as a hash value HASH.

FIG. 5 is a diagram illustrating an example of the request management table RQTBL2 and the data management table DTTBL2 of a stand-by site 200 illustrated in FIG. 3. The same reference numerals are given to the same elements as those described with reference to FIG. 4, and the detailed description thereof will be omitted.

Like the request management table RQTBL1 illustrated in FIG. 4, the request management table RQTBL2 has the plurality of entries including the areas RQID, RST, and TST, respectively. Further, since the information in the request management table RQTBL2 is stored after the data processing apparatus 110 transmits first data of the data group, “Start” is not stored but any one of “Writing” or “Finish” is stored in the area RST.

Like the data management table RQTBL1 illustrated in FIG. 4, the data management table RQTBL2 has the plurality of entries including the areas RQID, DNO, MINF, and HASH, respectively.

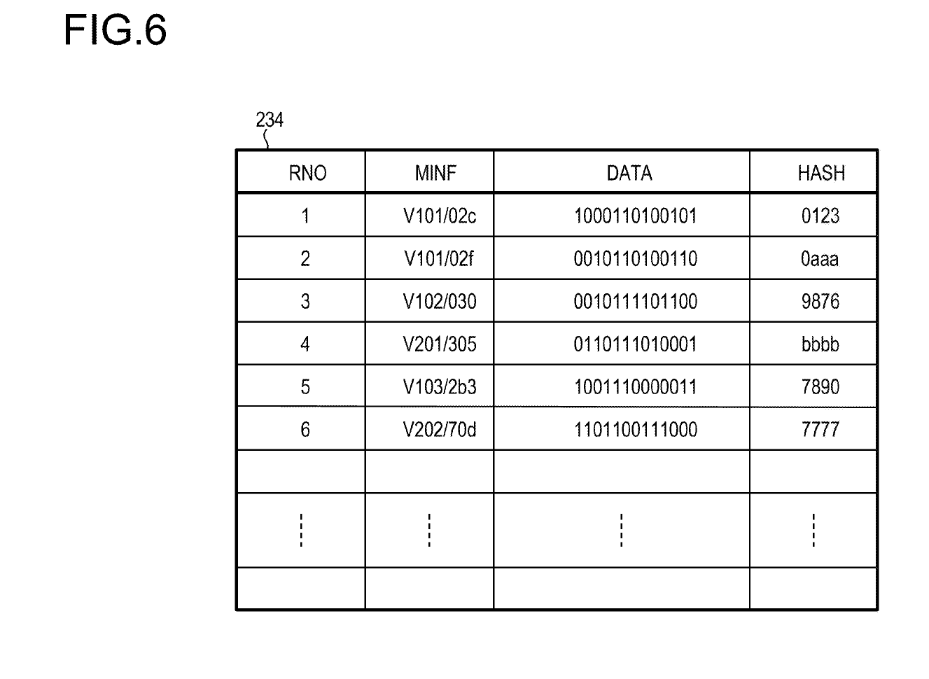

FIG. 6 illustrates an example of information held in the memory 234 of the stand-by site 200 illustrated in FIG. 3. A plurality of entries including the areas RNO, MINF, DATA, and HASH, respectively is allocated to the memory 234. The area number (serial number) is stored in the area RNO for each data. Hereinafter, the area number stored in the area RNO is also referred to as an area number RNO. Further, the area RNO may be omitted by using the entry number instead of the area number. The plurality of entries allocated to the memory 234 is an example of a plurality of holding areas to which any one of the plurality of area numbers RNO is allocated.

Like the area MINF of the data management table DTTBL1 illustrated in FIG. 4, the area MINF stores the LUN indicated by “V101,” “V102,” etc., and the memory area information MINF including the numbers of the sectors indicated by “02c,” “030,” etc. The data transmitted from the storage 130 and the data (binary number in FIG. 6) copied to the disk device 232 are stored in the area DATA.

The data stored in the area DATA is area data held in the memory area (for example, a sector) of the disk device 132 in which the data output from the data processing apparatus 110 is written. In addition, actually, the size of the data stored in the area DATA is, for example, 4 kilobytes.

In the area HASH, the hash value of the area data stored in the area DATA is stored. The hash value is calculated by the storage 230 based on storing of the area data in the area DATA.

For example, the data management unit 244 illustrated in FIG. 3 manages the memory area information MINF and the data DATA stored in each entry of the memory 234 with the area number RNO having a smaller information amount than the memory area information MINF. By notifying the area number RNO instead of notifying the memory area information MINF to the storage 230, the data management unit 244 may control the operation of the storage 230 by suppressing the amount of the information output to the storage 230.

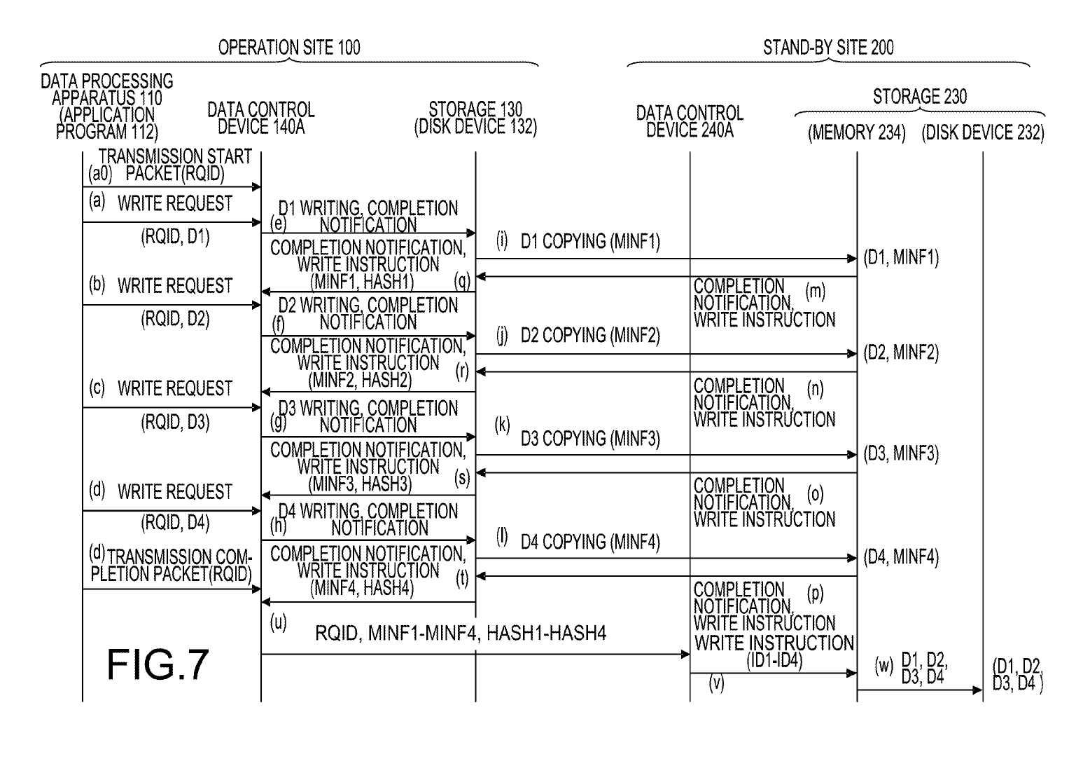

FIG. 7 is a diagram illustrating an example of an overview of an operation of the information processing system 10A illustrated in FIG. 3. That is, FIG. 7 illustrates an example of an information processing method by the information processing system 10A. The same reference numerals are given to the same or similar operation as those described with reference to FIG. 2, and the detailed description thereof will be omitted. Even in the example illustrated in FIG. 7, similarly to FIG. 2, the data processing apparatus 110 stores four data D (D1, D2, D3, and D4) included in the data group in the storage 130.

First, before transmitting the data D1 to D4, the data processing apparatus 110 issues the transmission start packet indicating the start of the transmission of the data D1 to D4 to the data control device 140A ((a0) in FIG. 7). The transmission start packet includes the request number RQID for identifying the data D1 to D4. Thereafter, the data processing apparatus 110 issues four write request packets including the request number RQID and each of the data D1 to D4 to the data control device 140A ((a), (b), (c), and (d) in FIG. 7). After transmitting the data D1 to D4, the data processing apparatus 110 issues the transmission completion packet indicating the completion of the transmission of the data D1 to D4 to the data control device 140A ((d2) in FIG. 7). The transmission completion packet includes the request number RQID for identifying the data D1 to D4.

Each time the data control device 140A receives the write request, the data control device 140 outputs the write request for writing the data D included in the write request in the disk device 132 to the storage 130 ((e), (f), (g), and (h) in FIG. 7). The write request output by the data control device 140A to the storage 130 is an example of a first write request. The storage 130 outputs the data D (D1, D2, D3, and D4) written in the disk device 132 to the storage 230 together with the memory area information MINF (MINF1, MINF2, MINF3, and MINF4) ((i), (j), (k), and (l) in FIG. 7).

Each time the storage 230 receives the data D, the storage 230 writes the received data D in the memory 234 in association with the memory area information MINF and then issues the completion notification indicating the completion of the writing in the memory 234 to the storage 130 ((m), (n), (o), and (p) in FIG. 7). That is, the data output from the storage 130 is copied to the memory 234. Further, in FIG. 7, although the completion notification of the writing of data from the data control device 140A into the data processing apparatus 110 is not described, the data is copied from the storage 130 to the storage 230, for example, in an asynchronous mode. In the asynchronous mode, the data control device 140A outputs a write completion notification to the data processing apparatus 110 without waiting for the notification of the writing of the data from the storage 230 based on the completion of the writing of the data in the disk device 132.

Each time the storage 130 receives the completion notification from the storage 230, the storage 130 issues the completion notification including the memory area information MINF and the hash value HASH corresponding to the data D written in the storage 230 to the data control device 140A ((q), (r), (s), and (t) in FIG. 7).

The data control device 140A determines that all of the data D1 to D4 included in the data group are copied to the stand-by site 200, based on the reception of all the completion notifications corresponding to the data D1 to D4, respectively. In addition, the data control device 140A transmits the request number RQID, and the memory area information MINF1 to MINF4 and the hash values HASH1 to HASH4 corresponding to the data D1 to D4, respectively to the data control device 240A ((u) in FIG. 7).

The data control device 240A issues to the storage 230 the write instruction to write the data D1 to D4 (that is, data group) held in the memory 234 in the disk device 232 together with the received memory area information MINF1 to MINF4 and hash values HASH1 to HASH4 ((v) in FIG. 7). The storage 230 that receives the write instruction writes in the disk device 232 the data D1 to D4 corresponding to the received memory area information MINF and hash values HASH among the plurality of data held in the memory 234 ((w) in FIG. 7). As a result, similarly to FIG. 2, it is possible to write the data D1 to D4 written in the disk device 132 of the operation site 100 in the disk device 232 of the stand-by site 200 by unit of the data group.

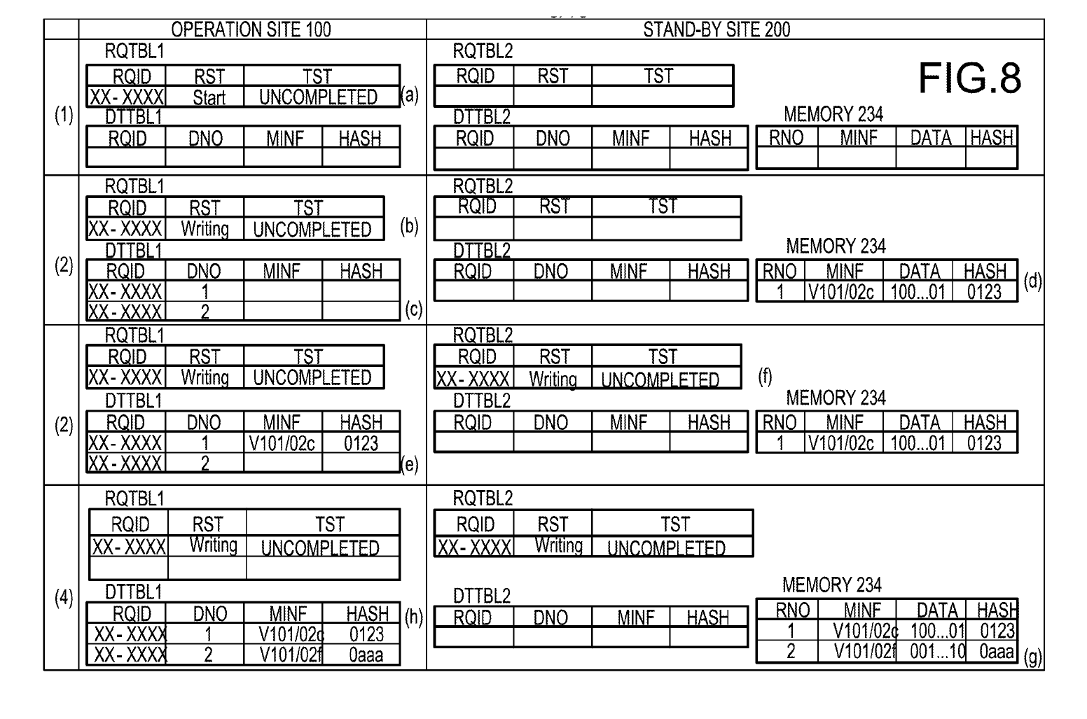

FIGS. 8 to 11 are diagrams illustrating an example of the operation of the information processing system 10A illustrated in FIG. 3. That is, FIGS. 8 to 11 illustrate an example of the information processing method by the information processing system 10A. The detailed description of operations similar to those described with reference to FIG. 7 will be omitted.

First, in a state (1) illustrated in FIG. 8, the data control device 140A of the operation site 100 receives the transmission start packet including the request number RQID (XX-XXXX) from the data processing apparatus 110. The request management unit 142 of the data control device 140A stores the request number RQID (XX-XXXX) included in the transmission start packet in a vacant entry of the request management table RQTBL1. Further, the request management unit 142 sets the area RST storing the request number RQID to “Start” and sets the area TST storing the request number RQID to “uncompleted” ((a) in FIG. 8).

Next, in a state (2), the data control device 140A receives the write request packet from the data processing apparatus 110. In the request management table RQTBL 1, the request management unit 142 sets the area RST of the entry holding the request number RQID included in the write request packet to “Writing” ((b) in FIG. 8). Each time the data management unit 144 receives the write request packet, the data management unit 144 stores the request number RQID included in the write request packet in the vacant entry of the data management table DTTBL1. Further, the data management unit 144 stores the data number DNO for identifying the data included in the write request packet in the entry of the data management table DTTBL1 storing the request number RQID ((c) in FIG. 8).

The data management unit 144 outputs to the storage 130 the write request including the data included in the write request packet, and the request number RQID and the data number DNO corresponding to the data. The storage 130 writes the data included in the write request in the disk device 132 and transmits the area data which is the data held in the memory area of the disk device 132 in which the data is written to the storage 230 together with the memory area information MINF. The memory area of the disk device 132 in which the data is written is, for example, the sector. The storage 130 holds the request number RQID and the data number DNO in association with the memory area information MINF in which the data is written until receiving the completion notification from the storage 230.

The storage 230 writes the area data DATA and the memory area information MINF received from the storage 130 in the memory 234 together with the area number RNO. Further, the storage 230 calculates the hash value of the area data written in the memory 234 and writes the calculated hash value in the area HASH ((d) in FIG. 8). The storage 230 outputs the write completion notification to the storage 130. Based on the completion notification from the storage 230, the storage 130 outputs the completion notification including the memory area information MINF, the request number RQID, the data number DNO, and the hash value HASH corresponding to the area data written in the memory 234 to the data management unit 144. The hash value HASH is the hash value of the area data held in the memory area of the disk device 132 in which the data is written and is calculated by the storage 130 based on an instruction from the data management unit 244. That is, the data management unit 244 causes the storage 130 to calculate the hash value.

Next, in a state (3), the data management unit 144 receives the completion notification including the memory area information MINF, the request number RQID, the data number DNO, and the hash value HASH from the storage 130. In addition, the data management unit 144 stores the memory area information MINF and the hash value HASH in the entry of the data management table DTTBL1 storing the received request number RQID and data number DNO ((e) in FIG. 8).

The communication management unit 146 transmits the request number RQID corresponding to the data group to the data control device 240A of the stand-by site 200, based on receiving the completion notification corresponding to the first data of the data group from the storage 130. The transmission of the request number RQID to the data control device 240A indicates the start of the copy processing of the data group to the disk device 232.

The request management unit 242 of the data control device 240A that receives the request number RQID stores the received request number RQID in any one area RQID of the vacant entry in the request management table RQTBL2. Further, the request management unit 242 sets the area RST of the entry storing the request number RQID to “Writing” and sets the area TST of the entry storing the request number RQID to “uncompleted” ((f) in FIG. 8).

Next, in a state (4), the storage 130 writes next data in the memory area of the disk device 132 and transmits the area data held in the memory area where the data is written to the storage 230 together with the memory area information MINF. Similarly to (d) in FIG. 8, the storage 230 writes the area data and the memory area information MINF received from the storage 130 in the memory 234 together with the area number RNO and writes the calculated hash value in the memory 234 ((g) in FIG. 8).

Based on the completion notification from the storage 230, the storage 130 outputs the completion notification including the memory area information MINF, the request number RQID, the data number DNO, and the hash value HASH corresponding to the area data written in the memory 234 to the data management unit 144. The data management unit 144 stores the memory area information MINF and the hash value HASH in the entry of the data management table DTTBL1 storing the received request number RQID and data number DNO ((h) in FIG. 8).

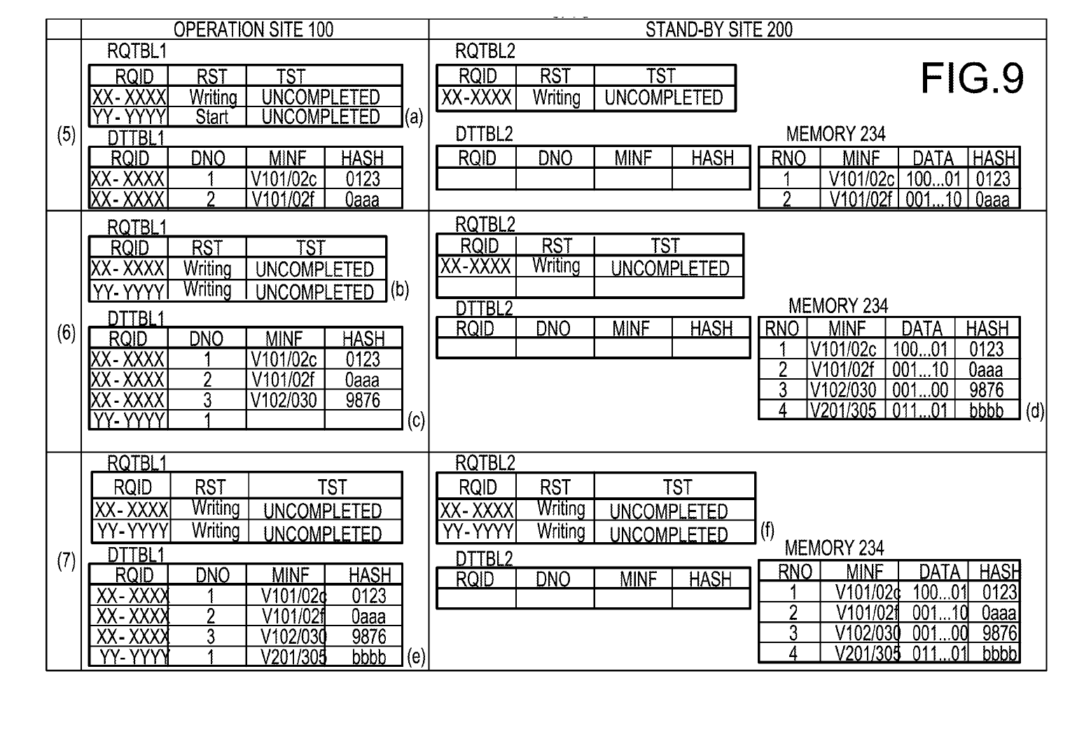

Next, in a state (5) illustrated in FIG. 9, the data control device 140A receives the transmission start packet including the request number RQID (YY-YYYY) from the data processing apparatus 110. The request management unit 142 stores the request number RQID (YY-YYYY) in the vacant entry of the request management table RQTBL1 and sets the areas RST and TST to “Start” and “uncompleted,” respectively ((a) in FIG. 9).

Next, in a state (6), the request management unit 142 changes “Start” of the request management table RQTBL1 (YY-YYYY) to “Writing” based on the write request packet from the data processing apparatus 110 ((b) in FIG. 9). The data management unit 144 stores the data number DNO for identifying the data included in the write request packet in the entry of the data management table DTTBL1 ((c) in FIG. 9).

Thereafter, the data included in the write request is written in the disk device 132 and the area data held in the memory area of the disk device 132 in which the data is written is transmitted to the storage 230 together with the memory area information MINF. The storage 230 writes the area data and the memory area information MINF received from the storage 130 in the memory 234 together with the area number RNO and writes the calculated hash value in the memory 234 ((d) in FIG. 9).

Next, in a state (7), the storage 130 that receives the completion notification from the storage 230 outputs the completion notification including the memory area information MINF, the request number RQID, the data number DNO, and the hash value HASH to the data management unit 144. The data management unit 144 stores the memory area information MINF and the hash value HASH included in the completion notification in the data management table DTTBL1 ((e) in FIG. 9).

Since the communication management unit 146 receives the completion notification corresponding to the first data of the data group from the storage 130, the communication management unit 146 transmits the request number RQID (YY-YYYY) corresponding to the data group to the data control device 240A of the stand-by site 200. The request management unit 242 of the data control device 240A stores the received request number RQID in the request management table RQTBL2 and sets the areas RST and TST of the entry storing the request number RQID to “Writing” and “uncompleted,” respectively ((f) in FIG. 9).

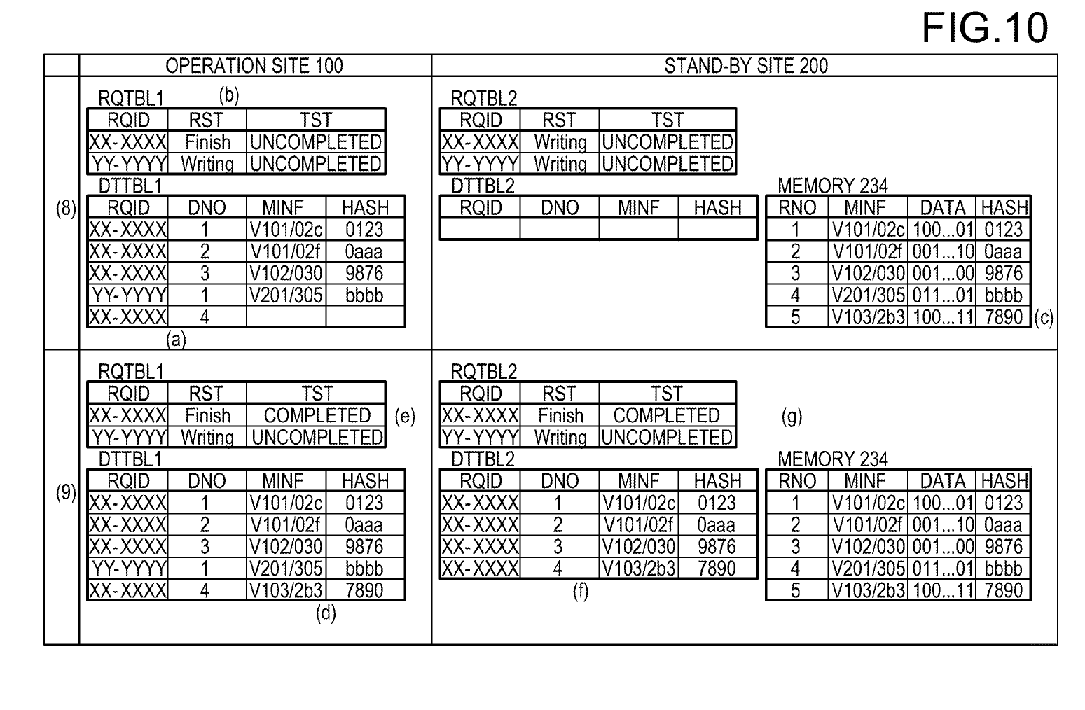

Next, in a state (8) illustrated in FIG. 10, the data control device 140A receives from the data processing apparatus 110 the write request packet including the last data among the plurality of data included in the data group. The data management unit 144 stores the request number RQID (XX-XXXX) included in the write request packet and the data number DNO for identifying the data included in the write request packet in the data management table DTTBL1 ((a) in FIG. 10).

Next, the data control device 140A receives the transmission completion packet including the request number RQID (XX-XXXX) from the data processing apparatus 110. The request management unit 142 changes the area TST of the entry of the request management table RQTBL1 holding the request number RQID (XX-XXXX) from “Writing” to “Finish” ((b) in FIG. 10).

The storage 130 writes the data received from the data control device 240A in the disk device 132 and transmits the area data which is held in the memory area of the disk device 132 in which the data is written to the storage 230 together with the memory area information MINF. The storage 230 writes the area data and the memory area information MINF received from the storage 130 in the memory 234 together with the area number RNO and writes the calculated hash value in the memory 234 ((c) in FIG. 10). The storage 230 outputs the write completion notification to the storage 130.

As described above, the data control device 140A manages a plurality of data included in each of a plurality of data groups received from the data processing apparatus 110 by using the request number RQID allocated to each data group. As a result, when data of the plurality of data groups are mixed and output from the data processing apparatus 110, the completion of the writing in the memory 234 may be determined for each data group and a plurality of memory area information MINF corresponding to the data group may be transmitted to the data control device 240A.

Next, in a state (9), the storage 130 receives the completion notification from the storage 230. Based on the completion notification, the storage 130 outputs the completion notification including the memory area information MINF, the request number RQID, the data number DNO, and the hash value HASH corresponding to the area data written in the memory 234 to the data management unit 144. The data management unit 144 stores the memory area information MINF and the hash value HASH in the entry of the data management table DTTBL1 storing the received request number RQID and data number DNO ((d) in FIG. 10).

The communication management unit 146 determines whether all data of the data group corresponding to the request number RQID (XX-XXXX) in which “Finish” is held in the entry of the request management table RQTBL1 are written in the memory 234. In the data management table DTTBL1, when the memory area information MINF and the hash value HASH are held in all entries in which “XX-XXXX” is held, it is determined that all data of the data group are written in the memory 234.

The communication management unit 146 transmits the data number DNO, the memory area information MINF, and the hash value HASH held in all of the entries of the data management table DTTBL1 holding “XX-XXXX” to the data control device 240A together with the request number RQID. Further, the communication management unit 146 notifies the request management unit 142 that all of the data of the data group corresponding to the request number RQID=“XX-XXXX” are written in the memory 234. The request management unit 142 changes “uncompleted” of the area TST of the entry of the request management table RQTBL1 holding “XX-XXXX” to “completed” based on the notification from the communication management unit 146 ((e) in FIG. 10).

The data management unit 244 of the data control device 240A stores the request number RQID, the data number DNO, the memory area information MINF, and the hash value HASH received from the communication management unit 146 in the data management table DTTBL2 ((f) in FIG. 10). The request management unit 242 of the data control device 240A updates the request management table RQTBL2 based on reception of the request number RQID, the data number DNO, the memory area information MINF, and the hash value HASH from the data control device 140A. That is, the request management unit 242 sets the areas RST and TST of the entry of the request management table RQTBL2 holding the request number RQID (XX-XXXX) to “Finish” and “completed,” respectively ((g) in FIG. 10).

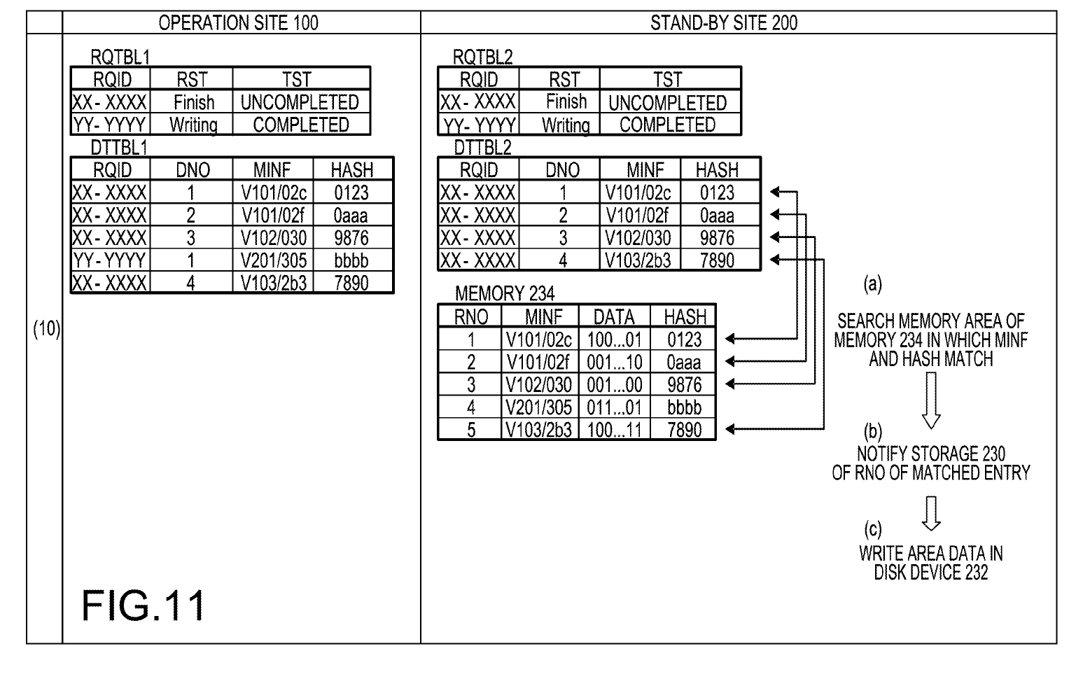

Next, in a state (10) illustrated in FIG. 11, the data management unit 244 of the stand-by site 200 detects that “Finish” is held in any one of the entries of the request management table RQTBL2. The data management unit 244 refers to the request number RQID (XX-XXXX) stored in the entry holding “Finish” in the request management table RQTBL2. The data management unit 244 searches the information held in the memory 234 and detects the memory area of the memory 234 holding information which is the same as the memory area information MINF stored in the entry of the data management table DTTBL2 holding the referenced request number RQID. In the example illustrated in FIG. 11, a plurality of memory area information MINF held in the memory areas with the area numbers RNO of “1,” “2,” “3,” and “5” of the memory 234, respectively matches the plurality of memory area information MINF held in the data management table DTTBL2, respectively.

The data management unit 244 searches the information held in the memory 234 and determines whether the hash value held in the memory area of the memory 234 matching the memory area information MINF matches the hash value held in the data management table DTTBL2. Here, the determination of the matching is performed by comparing the hash values held in the entries of the data management table DTTBL2 whose memory area information MINF matches each other and the memory area of the memory 234, respectively ((a) in FIG. 11).

The data management unit 244 notifies the storage unit 230 of the area number RNO indicating each of the memory areas of the memory 234 having the same hash value. In the example illustrated in FIG. 11, the data management unit 244 notifies the storage 230 of four area numbers RNO (“1,” “2,” “3,” and “5”) ((b) in FIG. 11). The storage 230 writes the area data DATA corresponding to the area number RNO notified from the data management unit 244 in the memory area of the disk device 232 indicated by the memory area information MINF corresponding to the area number RNO notified from the data management unit 244 ((c) in FIG. 11). By notifying the storage 230 of the area number RNO instead of the memory area information MINF, it is possible to reduce the amount of information used for the notification, as compared with the case of notifying the memory area information MINF. As a result, it is possible to facilitate the control executed between the data control device 240A and the storage 230.

When the hash values do not match each other, it is determined that an error occurs in the area data held in the memory 234 and error processing such as re-transmitting the area data from the disk device 132 to the memory 234 again is executed. In addition, when the same memory area information MINF is held in the plurality of memory areas of the memory 234, correct area data is read from the memory 234 by selecting the memory area having the same hash value to write the correct area data in the disk device 232. Therefore, it is possible to prevent incorrect area data from being written in the disk device 232. For example, it is assumed that when the hash value in which the area number RNO is “1” is “0123” and the hash value in which the area number RNO is “6” is “0122” so that the memory area information MINF and the area data DATA are equal to each other in the memory areas having the area numbers RNO “1” and “6.” In this case, the data management unit 244 determines that the area data DATA having the area number RNO of “1,” which holds the same information as the memory area information MINF “V101/02c” and the hash value “0123” held in the data management table DTTBL2 is correct.

As a result, it is possible to copy the data written in the disk device 132 of the operation site 100 to the disk device 232 of the stand-by site 200 by unit of the data group. Since each of the data written in the disk devices 132 and 232 is held in the memory area indicated by the same memory area information MINF, when the operation of the system is switched from the operation site 100 to the stand-by site 200, the operation of the data may be continued.

FIG. 12 illustrates an example of an operational flow of the request management unit 142 of the operation site 100 illustrated in FIG. 3. That is, FIG. 12 illustrates an example of the information processing method by the information processing system 10A. The flow illustrated in FIG. 12 is repeatedly executed at a predetermined cycle.

First, in step S100, when the request management unit 142 receives the transmission start packet from the data processing apparatus 110, the processing proceeds to step S102. When the request management unit 142 does not receive the transmission start packet, the processing proceeds to step S104. In step S102, the request management unit 142 selects any one of the vacant entries in the request management table RQTBL1 and stores the request number RQID included in the transmission start packet in the area RQID of the selected entry. Further, the request management unit 142 sets the area RST of the entry storing the request number RQID to “Start” and sets the area TST of the entry storing the request number RQID to “uncompleted.” After step S102, the processing proceeds to step S104.

In step S104, when the request management unit 142 receives the write request packet from the data processing apparatus 110, the processing proceeds to step S106. When the request management unit 142 does not receive the write request packet, the processing proceeds to step S108. In step S106, in the request management table RQTBL1, the request management unit 142 changes the area RST of the entry holding the request number RQID included in the write request packet from “Start” to “Writing.” Further, when the area RST of the entry holding the request number RQID is set to “Writing,” the processing of step S106 may be omitted. After step S106, the processing proceeds to step S108.

In step S108, when receiving the transmission completion packet from the data processing apparatus 110, the request management unit 142 makes the processing proceed to step S110 and when not receiving the transmission completion packet, the request management unit 142 terminates the processing. In step S110, in the request management table RQTBL1, the request management unit 142 changes the area RST of the entry holding the request number RQID included in the transmission completion packet from “Writing” to “Finish.” After step S110, the processing is terminated.

FIG. 13 illustrates an example of the operational flow of the data management unit 144 of the operation site 100 illustrated in FIG. 3. That is, FIG. 13 illustrates an example of an information processing method by the information processing system 10A. The flow illustrated in FIG. 13 is repeatedly executed at a predetermined cycle.

First, in step S200, when the data management unit 144 receives the write request packet from the data processing apparatus 110, the processing proceeds to step S202. When the data management unit 144 does not receive the write request packet, the processing proceeds to step S208. In step S202, the data management unit 144 selects any one of the vacant entries in the data management table DTTBL1 and stores the request number RQID included in the write request packet in the area RQID of the selected entry. Further, the data management unit 144 stores the data number DNO in the area DNO of the selected entry.

Next, in step S204, the data management unit 144 extracts data from the payload PL of the write request packet. Next, in step S206, the data management unit 144 outputs to the storage 130 of the operation site 100 the write request including the data extracted from the write request packet, and the request number RQID and the data number DNO corresponding to the data. After step S206, the processing proceeds to step S208.

The storage 130 that receives the write request writes the data included in the write request in the disk device 132 and transmits the data written in the disk device 132 to the storage 230 together with the memory area information MINF. In addition, based on the completion notification from the storage 230, the storage 130 outputs the memory area information MINF, the request number RQID, the data number DNO, and the hash value HASH corresponding to the completion notification to the data management unit 244. The hash value HASH is the hash value of the area data held by the memory area indicated by the memory area information MINF.

In step S208, when the data management unit 144 receives the request number RQID, the data number DNO, the memory area information MINF, and the hash value HASH from the storage 130, the processing proceeds to step S210. When the data management unit 144 does not receive the request number RQID, the data number DNO, the memory area information MINF, and the hash value HASH from the storage 130, the processing is terminated.

In step S210, the data management unit 144 selects an entry in which the request number RQID and the data number DNO received from the storage 130 are stored in the data management table DTTBL1. In addition, the data management unit 144 stores the memory area information MINF and the hash value HASH received from the storage 130 in the selected entry. After step S210, the processing is terminated.

FIG. 14 illustrates an example of the operational flow of the communication management unit 146 of the operation site 100 illustrated in FIG. 3. That is, FIG. 14 illustrates an example of the information processing method by the information processing system 10A. The flow illustrated in FIG. 14 is repeatedly executed at a predetermined cycle.

First, in step S300, when the communication management unit 146 completes the writing of the area data including the first data of the data group in the memory 234, the processing proceeds to step S302. When the communication management unit 146 does not complete the writing of the area data including the first data of the data group in the memory 234, the processing is terminated. The completion of the writing of the area data including the first data of the data group in the memory 234 is determined based on the completion notification from the storage 130. In step S302, the communication management unit 146 transmits the request number RQID corresponding to the data group to the data control device 240A of the stand-by site 200, and the processing proceeds to step S304.

In step S304, when the communication management unit 146 has an entry in which “Finish” is stored in the area RST of the request management table RQTBL1, the processing proceeds to step S306. In step S304, when the communication management unit 146 does not have an entry in which “Finish” is stored in the area RST of the request management table RQTBL1, the processing is terminated.

In step S306, the communication management unit 146 extracts the request number RQID from the entry storing “Finish” in the request management table RQTBL1. The communication management unit 146 determines whether the memory area information MINF and the hash value HASH are stored in a plurality of entries in which the request number RQID extracted from the request management table RQTBL1 is stored in the data management table DTTBL1. When there is a target entry in which the memory area information MINF and the hash value HASH are stored, the processing proceeds to step S308 and when there is no target entry storing the memory area information MINF and the hash value HASH, the processing is terminated.

In step S308, the communication management unit 146 reads the request number RQID, the data number DNO, the memory area information MINF, and the hash value HASH stored in each of the target entries in the data management table DTTBL1. In addition, the communication management unit 146 transmits the read plural sets of request number RQID, data number DNO, memory area information MINF and hash value HASH to the data control device 240A of the stand-by site 200.

Next, in step S310, the communication management unit 146 changes the area TST of the entry of the request management table RQTBL1 from which the request number RQID is extracted in step S306 from “uncompleted” to “completed” and terminates the processing.

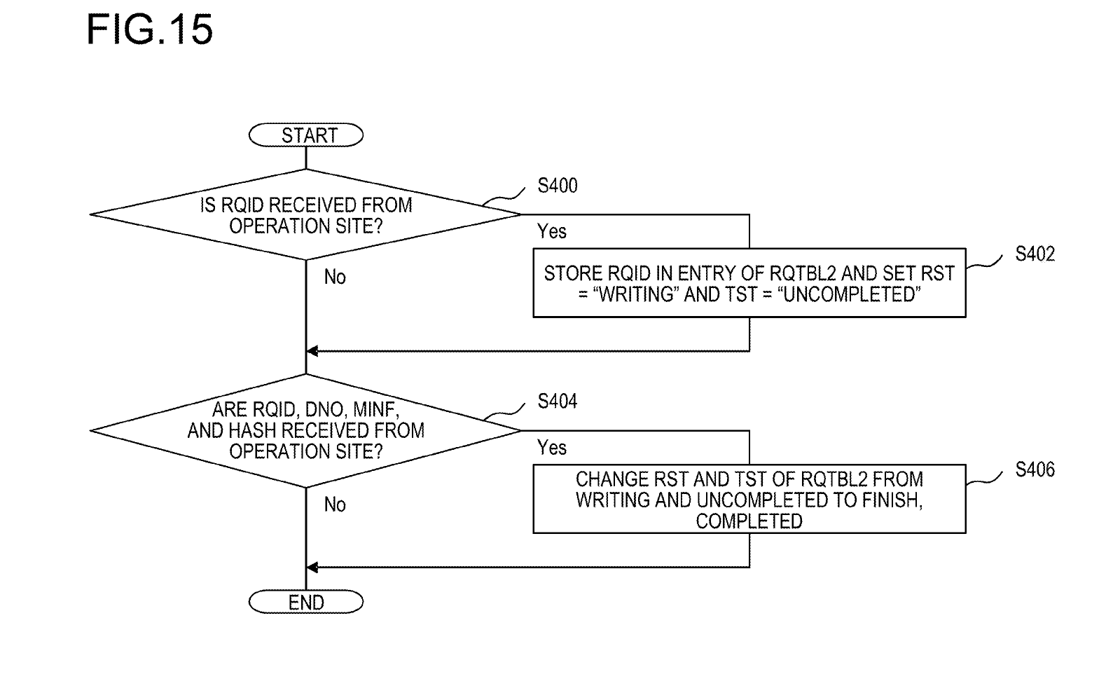

FIG. 15 illustrates an example of the operational flow of the request management unit 242 of the stand-by site 200 illustrated in FIG. 3. That is, FIG. 15 illustrates an example of the information processing method by the information processing system 10A. The flow illustrated in FIG. 15 is repeatedly executed at a predetermined cycle.

First, in step S400, when the request management unit 242 receives the request number RQID from the data control device 140A of the operation site 100, the processing proceeds to step S402. When the request management unit 142 does not receive the request number RQID, the processing proceeds to step S404. In step S402, the request management unit 242 stores the request number RQID in any one of the vacant entries of the request management table RQTBL2 and sets the areas RST and TST to “Writing” and “uncompleted,” respectively. After step S402, the processing proceeds to step S404.

In step S404, when the request management unit 242 receives the request number RQID, the data number DNO, the memory area information MINF, and the hash value HASH from the data control device 140A of the operation site 100, the processing proceeds to step S406. When the request management unit 242 does not receive the request number RQID, the data number DNO, the memory area information MINF, and the hash value HASH from the data control device 140A of the operation site 100, the processing is terminated.

In step S406, in the request management table RQTBL2, the request management unit 242 sets the areas RST and TST of the entry holding the received request number RQID to “Finish” and “completed,” respectively and terminates the processing.

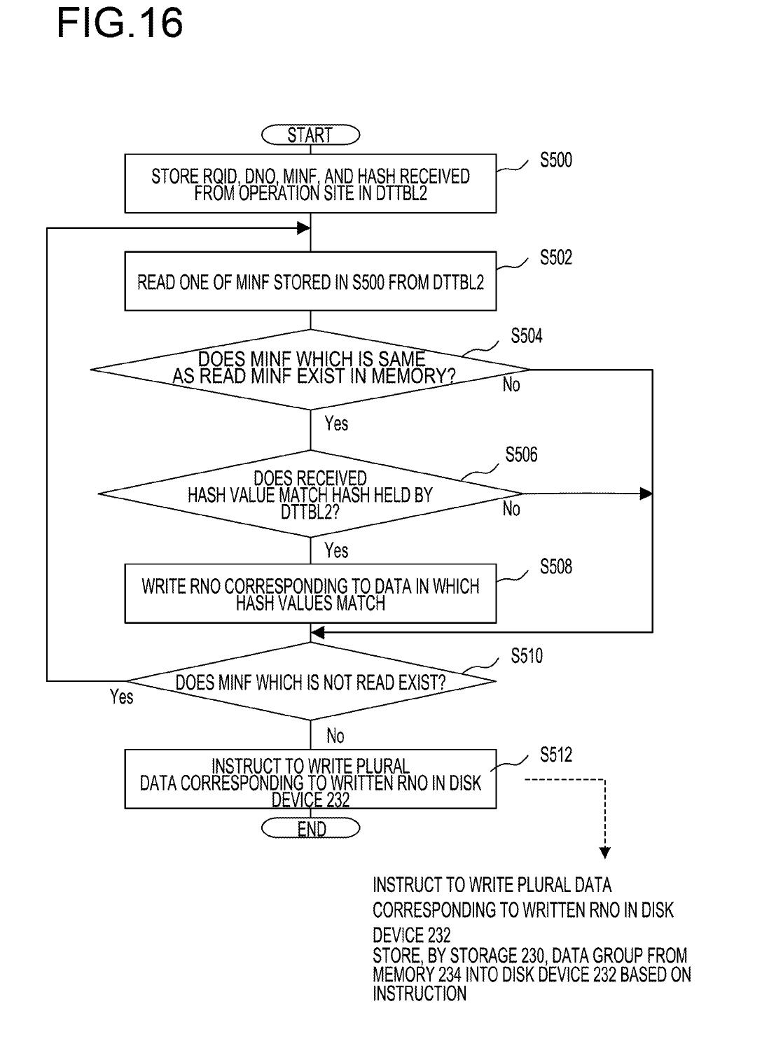

FIG. 16 illustrates an example of the operational flow of the data management unit 244 of the stand-by site 200 illustrated in FIG. 3. That is, FIG. 16 illustrates an example of an information processing method by the information processing system 10A. The processing illustrated in FIG. 16 starts based on reception of the information held in the data management table DTTBL1 transmitted by the communication management unit 146 of the operation site 100 by the communication management unit 246 of the data control device 240A in step S308 of FIG. 14.

First, in step S500, the data management unit 244 stores plural sets of request number RQID, data number DNO, memory area information MINF, and hash value HASH received from the operation site 100 in the data management table DTTBL2. Herein, the plural sets of request number RQID, data number DNO, memory area information MINF and hash value HASH received from the operation site 100 correspond to a plurality of data included in the data group of which writing in the memory 234 is completed.

Next, in step S502, the data management unit 244 reads one of the memory area information MINF stored in the data management table DTTBL2 in step S500 from the data management table DTTBL2. Next, in step S504, the data management unit 244 determines whether the same memory area information MINF as the memory area information MINF read from the data management table DTTBL 2 is held in the memory 234. When the same memory area information MINF is held in the memory 234, the processing proceeds to step S506 and when the same memory area information MINF is not held in the memory 234, the processing proceeds to step S 512.

In step S506, the data management unit 244 determines whether the hash value held in the memory 234 matches the hash value HASH held in the entry from which the memory area information MINF is read in the data management table DTTBL2. When the hash values match each other, the processing proceeds to step S508 and when the hash values do not match each other, the processing proceeds to step S510. Further, as described in (a) of FIG. 11, the determination of the matching of the hash value is performed by comparing the hash values held in the entries of the data management table DTTBL2 whose memory area information MINF matches each other and the memory area of the memory 234, respectively.

In step S508, the data management unit 244 writes the area number RNO stored in the entry of the memory 234 together with the data whose hash values match each other, and the processing proceeds to S510. Further, as illustrated in FIG. 6, since each entry of the memory 234 holds the area number RNO, the memory area information MINF, and the data DATA, the memory area information MINF and the data DATA may be specified based on the area number RNO.

In step S510, the data management unit 244 returns the processing to step S502 when the memory area information MINF that is not read exists in the data management table DTTBL2. Further, when the data management unit 244 reads all of the memory area information MINF held by the data management table DTTBL2, the processing proceeds to step S512.

In step S512, the data management unit 244 notifies the storage 230 of the plurality of area numbers RNO written in step S508. That is, the data management unit 244 issues an instruction to the storage 230 to write the area data held in the memory 234 in the disk device 232, corresponding to each of the plurality of area numbers RNO. Here, the plurality of area data instructed to be written includes the data group linked by the request number RQID.

The storage 230 extracts the area data and the memory area information MINF held in the entry of the memory 234 corresponding to each of the plurality of area numbers RNO received from the data management unit 244 based on the writing instruction. In addition, the storage 230 writes the extracted area data in the memory area of the disk device 232 indicated by the extracted memory area information MINF. As a result, the storage 230 may write the data in the disk device 232 by unit of the data group liked by the request number RQID.

Hereinabove, similarly to the embodiment FIG. 1, even in the embodiment illustrated in FIGS. 3 to 16, it is possible to write the data written in the disk device 132 of the operation site 100 in the disk device 232 of the stand-by site 200 by unit of the data group. As a result, even when the operation site 100 goes down, the consistency of the data at the execution level of the application program 112 may be guaranteed and the operation of the system may be continued by the data held in the disk device 232. Further, by identifying the data included in the data group by using the numbers of RUN and sectors transmitted and received between the storages 130, 230, it is easier to control the identification of data as compared with the case of using other information.

In the embodiment illustrated in FIGS. 3 to 16, the following effects may be obtained. That is, even when the storage 130 copies data to the storage 230 without going through the data control device 140A, the data control devices 140A and 240A may execute a control of writing the data in the disk device 232 for each data group based on the memory area information MINF.

Even when the same memory area information MINF is held in the plurality of memory areas of the memory 234, the data management unit 244 may select the correct area data from the memory 234 based on the hash value and write the selected area data in the disk device 232. Therefore, it is possible to prevent the incorrect area data from being written in the disk device 232.

The data control device 140A receives the data included in the data group together with the request number RQID for identifying the data group from the data processing apparatus 110 and manages the received data using the request number RQID. As a result, even when data of the plurality of data groups are mixed and output from the data processing apparatus 110, the completion of the writing in the memory 234 may be determined for each data group and a plurality of memory area information MINF corresponding to the data group may be transmitted to the data control device 240A. That is, even when the plurality of data included in each of a plurality of data groups are mixed and output from the data processing apparatus 110, the data held in the memory 234 may be written in the disk device 232 for each data group.

The data control device 240A notifies the storage 230 of the area data to be written from the memory 234 to the disk device 232 using the area number RNO instead of the memory area information MINF. This makes it possible to reduce the amount of information used for notification, compared to the case in which the area data to be written from the memory 234 into the disk device 232 using the memory area information MINF is notified to the storage 230. As a result, it is possible to facilitate the control executed between the data control device 240A and the storage 230.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system, comprising:
a first information processing apparatus including:
a first memory; and
at least one primary processor coupled to the first memory; and
a second information processing apparatus including:
a second memory;
a third memory; and
at least one secondary processor coupled to the second memory and the third memory,
wherein
the at least one primary processor is configured to:
write, upon receiving each of plural pieces of data, the received piece of data in the first memory, the plural pieces of data being included in a data group; and
transmit the received piece of data to the second information processing apparatus together with first identification information for identifying the received piece of data,
the at least one secondary processor is configured to:
write the piece of data in the third memory in association with the first identification information upon receiving the piece of data together with the first identification information; and
transmit a completion notification to the first information processing apparatus, the completion notification indicating completion of writing,
the at least one primary processor is configured to:
receive the completion notification;
determine whether all of the plural pieces of data are written in the third memory based on the received completion notification; and
transmit a plurality of first identification information to the second information processing apparatus upon determining that all of the plural pieces of data are written in the third memory, the plurality of first identification information respectively corresponding to the plural pieces of data, and
the at least one secondary processor is configured to:
write, in the second memory, plural pieces of data held in the third memory that respectively correspond to the plurality of first identification information received from the first information processing apparatus.

2. The information processing system according to claim 1, wherein
the first memory has first memory areas,
the first identification information indicates a memory area of the first memory areas in which the piece of data identified by the first identification information is written,
the second memory has second memory areas respectively corresponding to the first memory areas, and
the at least one secondary processor is configured to:
write the plural pieces of data in the second memory areas respectively corresponding to the first memory areas indicated by the plurality of first identification information.

3. The information processing system according to claim 2, wherein
the at least one primary processor includes a first processor coupled to the first memory and a second processor,
the at least one secondary processor includes a third processor coupled to the second memory and the third memory and a fourth processor,
the first information processing apparatus further includes:
a first storage that includes the first memory and the first processor; and
a first control device that includes the second processor,
the second information processing apparatus further includes:
a second storage that includes the second memory, the third memory, and the third processor; and
a second control device that includes the fourth processor,
the second processor is configured to:
output a first write request to the first storage upon receiving each of the plural pieces of data, the first write request including the received piece of data;
the first processor is configured to:
write, upon receiving the first write request, the piece of data included in the first write request in any one of the first memory areas; and
output a piece of area data, which is the piece of data written in the one of the first memory areas, to the second storage together with the first identification information indicating the one of the first memory areas,
the third processor is configured to:
write the piece of area data and the first identification information received from the first storage in the third memory in association with each other; and
transmit the completion notification to the first storage,
the first processor is configured to:
output, upon receiving the completion notification from the second storage, the first identification information corresponding to the piece of area data written in the third memory to the first control device,
the second processor is configured to:
receive the first identification information;
determine whether all of the plural pieces of data are written in the third memory based on the received first identification information; and
transmit, upon determining that all of the plural pieces of data are written in the third memory, a plurality of first identification information respectively corresponding to the plural pieces of data to the second control device,
the fourth processor is configured to:
output, upon receiving the plurality of first identification information from the first control device, a second write request to the second storage, a second write request including the plurality of first identification information, and
the third processor is configured to:
write the plural pieces of area data in the second memory upon receiving the second write request from the second control device, the plural pieces of area data being held in the third memory respectively in association with the plurality of first identification information.

4. The information processing system according to claim 3, wherein
the first processor is configured to:
output, upon receiving the completion notification from the second storage, a hash value of the piece of area data held in the memory area indicated by the first identification information together with the first identification information to the first control device,
the second processor is configured to:
transmit, upon determining that all of the plural pieces of data are written in the third memory, a plurality of hash values that correspond to the plurality of first identification information to the second control device together with the plurality of first identification information, and
the fourth processor is configured to:
output, upon receiving the plurality of hash values and the plurality of first identification information from the first control device, the second write request to the second storage, the second write request including the plurality of first identification information corresponding to the plural pieces of area data whose hash values are equal to any of the received hash values, among the plural pieces of area data held in the third memory.

5. The information processing system according to claim 4, wherein
the fourth processor is configured to:
cause the second storage to calculate hash values of the plural pieces of area data held in the third memory; and
compare the hash values calculated by the second storage with the hash values received from the first control device.

6. The information processing system according to claim 3, wherein
the second processor is configured to:
receive each of the plural pieces of data included in the data group together with second identification information for identifying the data group;
hold a data number allocated to the received piece of data in association with the second identification information; and
output the first write request including the received piece of data, the second identification information, and the data number to the first storage,
the first processor is configured to:
output, upon receiving the completion notification from the second storage, the second identification information and the data number that correspond to the piece of area data written in the third memory to the first control device together with the first identification information corresponding to the piece of area data written in the third memory, and
the second processor is configured to:
hold the first identification information received from the first storage in association with the second identification information and the data number received from the first storage.

7. The information processing system according to claim 3, wherein
the third memory has a plurality of holding areas which respectively holds the area data and the first identification information and to which any one of a plurality of area numbers is allocated respectively,
the fourth processor is configured to:
output the plurality of area numbers to the second storage as the plurality of first identification information, and
the third processor is configured to:
write a plurality of area data held in the plurality of holding areas that correspond to the plurality of received area numbers, in the plurality of memory areas of the second memory, which are respectively indicated by the plurality of the first identification information held in the plurality of holding areas that correspond to the plurality of received area numbers.

8. An information processing apparatus, comprising:
a first memory;
a second memory; and
at least one processor coupled to the first memory and the second memory and the at least one processor configured to:
write, upon receiving each of plural pieces of data together with first identification information from a first information processing apparatus, the received piece of data in the second memory in association with the first identification information, the plural pieces of data being included in a data group, the first identification information identifying the received piece of data;
transmit a completion notification to the first information processing apparatus, the completion notification indicating completion of writing; and
write, in the first memory, plural pieces of data held in the second memory that respectively correspond to a plurality of first identification information received from the first information processing apparatus.

9. An information processing method, comprising:
writing by a computer, upon receiving each of plural pieces of data together with first identification information from a first information processing apparatus, the received piece of data in a second memory in association with the first identification information, the plural pieces of data being included in a data group, the first identification information identifying the received piece of data;
transmitting a completion notification to the first information processing apparatus, the completion notification indicating completion of writing; and
writing, in a first memory, plural pieces of data held in the second memory that respectively correspond to a plurality of first identification information received from the first information processing apparatus.
